(19) United States
(12) Patent Application Publication
(10) Pub. No.: US 2008/0180227 A1
(43) Pub. Date: Jul. 31, 2008

(54) METHODS AND APPARATUS FOR DETERMINING OPTIMAL RF TRANSMITTER PLACEMENT VIA A COVERAGE METRIC

(75) Inventors: Vinh Le, Fremont, CA (US); Morteza Zarrabian, Los Altos, CA (US)

Correspondence Address: INGRASSIA FISHER & LORENZ, P.C., 7010 E. COCHISE ROAD, SCOTTSDALE, AZ, 85253, US

(73) Assignee: Symbol Technologies, Inc., Holtsville, NY (US)

(21) Appl. No.: 11/669,887

(22) Filed: Jan. 31, 2007

(51) Int. Cl. G08B 1/00

(52) U.S. Cl. 340/286.02

(57) ABSTRACT

Systems and methods are provided for optimizing the placement of wireless transmitters or other RF components within an environment. A first one of the plurality of RF devices is initially placed at a first initial location within the spatial model, wherein the first initial location is determined with respect to the reference point. The coverage area for the first RF device is determined, and a second one of the plurality of RF devices is initially placed at a second initial location within the spatial model, wherein the second initial location is determined with respect to the coverage area of the first RF device. At least one of the first and second initial locations can be adjusted to improve the combined coverage area of the first and second RF devices.

### TECHNICAL FIELD

The present invention relates to wireless local area networks (WLANs) and other networks incorporating radio frequency (RF) elements and/or RF devices. More particularly, the present invention relates to methods for improving the placement of RF devices, such as access points, within an indoor or outdoor RF environment.

### BACKGROUND

There has been a dramatic increase in demand for mobile connectivity solutions utilizing various wireless components and WLANs. This generally involves the use of wireless access points that communicate with mobile devices using one or more RF channels (e.g., in accordance with one or more of the IEEE 802.11 standards).

At the same time, RFID systems have achieved wide popularity in a number of applications, as they provide a cost-effective way to track the location of a large number of assets in real time. In large-scale applications such as warehouses, retail spaces, and the like, many RFID tags may exist in the environment. Likewise, multiple RFID readers are typically distributed throughout the space in the form of entryway readers, conveyer-belt readers, mobile readers, and the like, and these multiple components may be linked by network controller switches and other network elements.

Because many different RF transmitters and other components may exist in a particular environment, the deployment and management of such systems can be difficult and time-consuming. For example, it is desirable to configure access points and other such RF components such that RF coverage is complete within certain areas of the environment. Accordingly, there exist various RF planning systems that enable a user to predict indoor/outdoor RF coverage. The result is a prediction as to where the transmitters should be placed within the environment. Such systems are unsatisfactory in a number of respects, however, as they often are unable to efficiently process the presence of gaps and holes in wireless coverage. Moreover, many of such systems often result in transmitters being clustered or otherwise placed in close proximity to each other, thereby resulting in undesirable RF interference between transmitters.

### BRIEF SUMMARY

In general, systems and methods are provided for optimizing the placement of RF components within an environment. In one embodiment, the system operates by initially defining a spatial model associated with the environment and comprising a reference point. A first one of the plurality of RF devices is initially placed at a first initial location within the spatial model, wherein the first initial location is determined with respect to the reference point. The coverage area for the first RF device is determined, and a second one of the plurality of RF devices is initially placed at a second initial location within the spatial model, wherein the second initial location is determined with respect to the coverage area of the first RF device. At least one of the first and second initial locations can be adjusted to improve the combined coverage area of the first and second RF devices.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is an example floor plan useful in depicting systems and methods in accordance with the present invention;

FIG. 2 is a conceptual top view of exemplary coverage areas for two RF transmitters in an environment;

FIGS. 3A and 3B depict the environment of FIG. 2 with changing location of a reference area; and

FIG. 4 is the environment of FIGS. 3A and 3B after relocation of the RF transmitters and redefinition of the reference area.

### DETAILED DESCRIPTION

The present invention relates to a method of streamlining the placement of access points and other such RF components by initially placing the components within the RF environment in an efficient manner. In this regard, the following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more micro-processors and/or other control devices. Similarly, other embodiments may be practiced using any number of data transmission and data formatting protocols in addition to those described herein. The systems and techniques described herein are therefore intended merely as exemplary embodiments.

For the sake of brevity, conventional techniques related to signal processing, data transmission, signaling, network control, the 802.11 family of specifications, wireless networks, RFID systems and specifications, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in equivalent embodiments.

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. The term “exemplary” is used in the sense of “example,” rather than “model.” Although the figures may depict example arrangements of elements, additional intervening elements, devices, features, or components may be present in an embodiment of the invention.

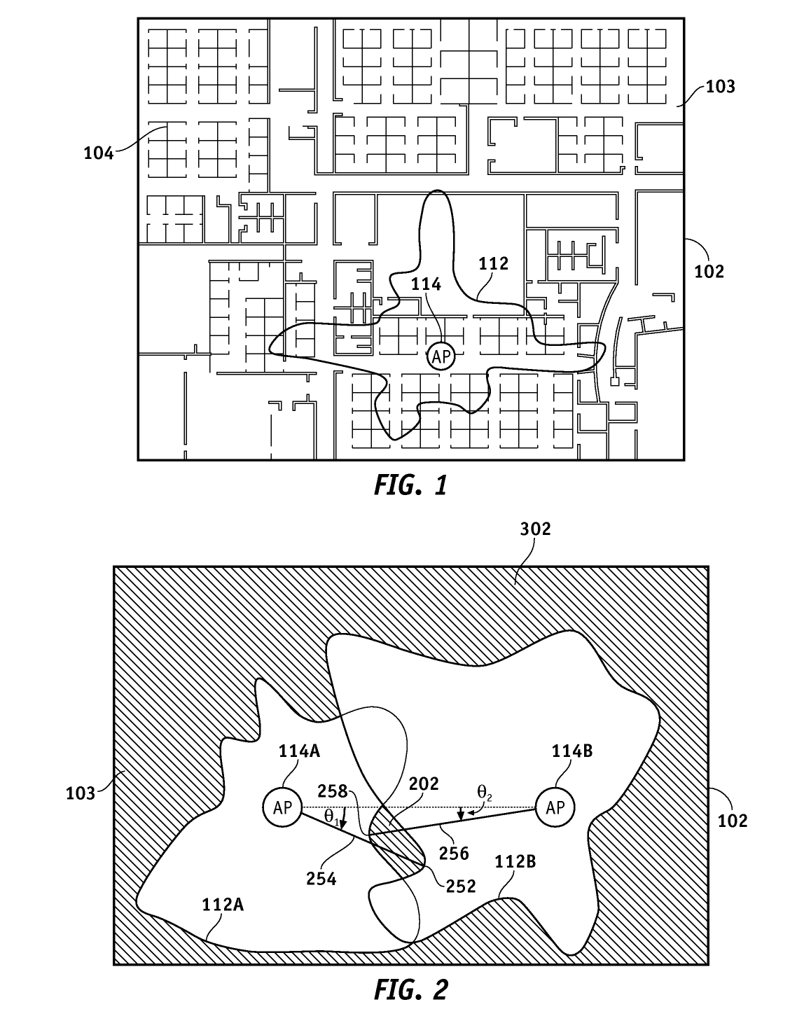

Referring to the conceptual plan view shown in FIG. 1, an access port or access point (“AP”) 114 or other RF device is provided within an environment 103 defined by a boundary 102 (which may be indoors and/or outdoors). AP 114 has an associated RF coverage area (or simply “coverage”) 112, which corresponds to the effective range of its antenna or RF transmitter, as described in further detail below. Various mobile units (“MUs”) (not shown) may communicate with AP 114, which itself will typically be part of a larger network.

Environment 103, which may correspond to a workplace, a retail store, a home, a warehouse, or any other such space (including outdoors and/or indoors), will typically include various physical features 104 that affect the nature and/or strength of RF signals received and/or sent by AP 114. Such feature include, for example, architectural structures such as doors, windows, partitions, walls, ceilings, floors, machinery, lighting fixtures, and the like.

Boundary 102 may have any arbitrary geometric shape, and need not be rectangular as shown in the illustration. Indeed, boundary 102 may comprise multiple topologically unconnected spaces, and need not encompass the entire workplace in which AP 114 is deployed. Furthermore, concepts described herein are not limited to two-dimensional layouts; they may be extended to three dimensional spaces as well.

AP 114 is configured to wirelessly connect to one or more mobile units (MUs) (not shown) and communicate one or more switches, routers, or other networked components via appropriate communication lines (not shown). Any number of additional and/or intervening switches, routers, servers, and other network components may also be present in the system.

At any given time, 114 may have a number of associated MUs, and is typically capable of communicating with through multiple RF channels. This distribution of channels varies greatly by device, as well as country of operation. For example, in accordance with a typical 802.11(b) deployment there are generally fourteen overlapping, staggered channels, each centered 5 MHz apart in the RF band.

As described in further detail below, AP 114 includes hardware, software, and/or firmware capable of carrying out the functions described herein. Thus, AP may comprise one or more processors accompanied by storage units, displays, input/output devices, an operating system, database management software, networking software, and the like. Such systems are well known in the art, and need not be described in detail here.

For wireless data transport, AP 114 may support one or more wireless data communication protocols—e.g., RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; cellular/wireless/cordless telecommunication protocols; wireless home network communication protocols; paging network protocols; magnetic induction; satellite data communication protocols; GPRS; and proprietary wireless data communication protocols such as variants of Wireless USB.

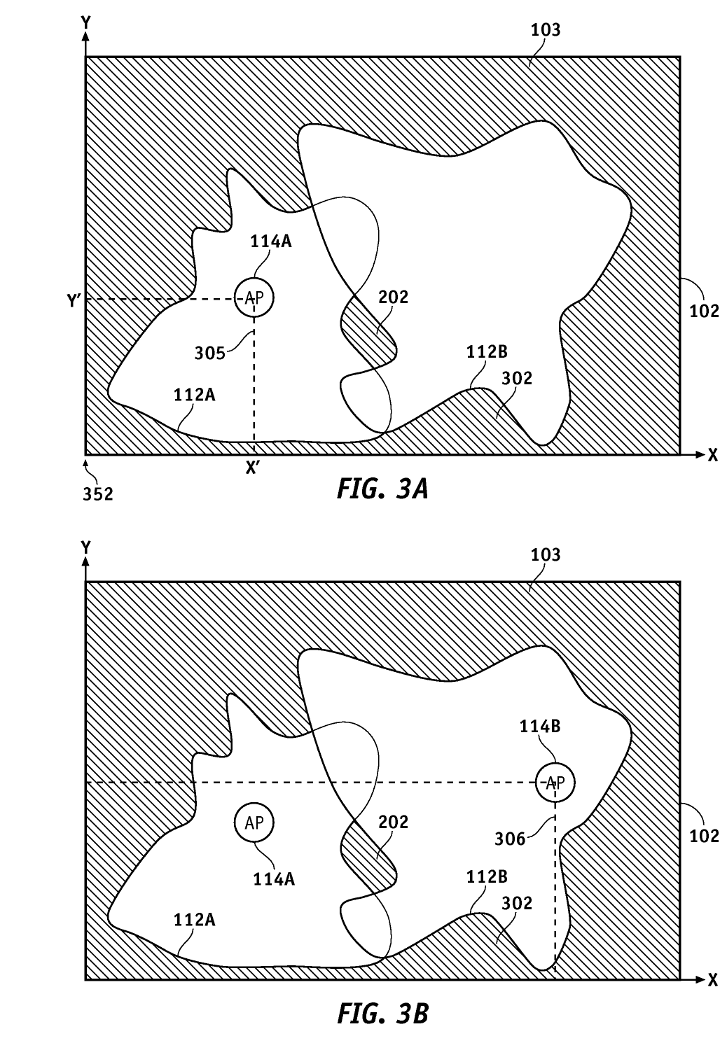

Referring now to FIG. 2, when multiple APs are positioned within boundary 102, various gaps or “holes” in coverage (or “coverage areas”) may exist. For simplicity, the gaps are shown be two-dimensional; in actual applications they may have a three-dimensional nature. In a typical application, AP 114A may have been previously placed (see, e.g., the discussion accompanying FIG. 5 below), and a new AP 114B is inserted to help with RF coverage. As illustrated, AP 114A has a corresponding coverage 112A, and AP 114B has a corresponding coverage 112B. These coverage areas may have any arbitrary shape or size, depending upon factors known in the art. For example, these coverage areas may be determined through a receiver signal strength indicator (RSSI) calculation, as is known in the art. RSSI calculations may be derived from actual observations of received signal strength, or may be simulated according to any technique.

Coverage areas 112A-B, then, represent those areas within boundary 102 that can be expected to provide an acceptable level of service. This “acceptable” level of service may correspond to those regions wherein received signal levels are expected to reliably exceed a minimally-acceptable level (e.g. wherein the observed or predicted RSSI value exceeds an acceptable minimum value). Alternatively, other metrics of “acceptable” service could be used.

As shown, a gap 202 exists between coverage areas 112A and 112B, and a gap 204 exists between boundary 102 and the outer reaches of areas 112A and 112B. APs 114A and/or 114B can be appropriately relocated to optimal (or at least improved) positions based on a coverage metric, which may be iteratively recalculated adaptively until the metric reaches a predetermined coverage metric threshold (or simply “threshold”).

The coverage metric may be any quantitative or qualitative measure that identifies gaps within an area at any given time. In one embodiment, for example, the coverage metric is equal to the total planar area of all gaps within the relevant area. The coverage metric may also take into account and assist with reducing overlapping coverage areas.

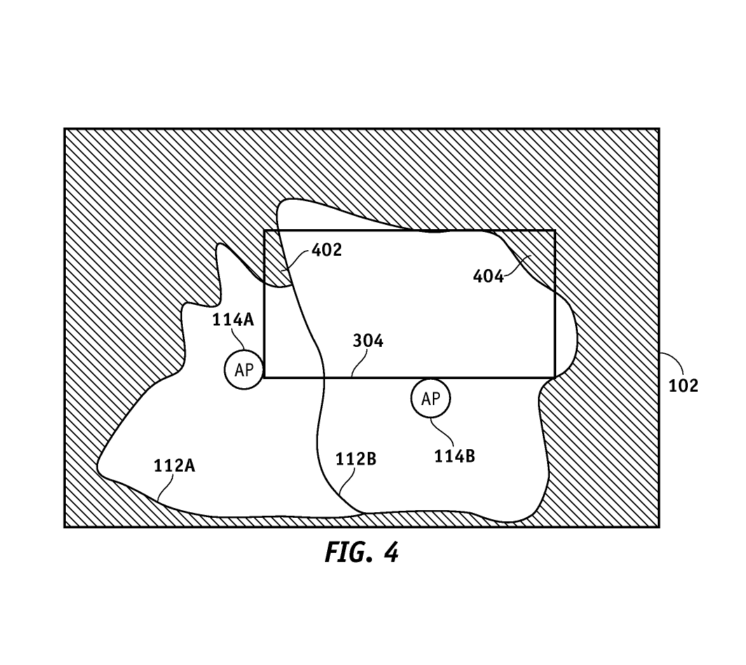

The coverage metric may be computed only within a subset of the space encompassed by boundary 102. That is, as shown in FIG. 3, a reference area (or “reference block”) 304 is defined, and the coverage metric may relate to how much RF coverage overlap can be allowed. The coverage metric calculations can be thusly computed based on gaps in RF coverage present in the environment—which may change size and/or position as various APs 114 are moved to reduce or otherwise change the coverage metric within that area. In the illustrated embodiment, for example, two gaps are present: gap 202 and gap 302. Each of these gaps has planar geometrical attributes such as area, shape, centroid, and the like, all of which may be calculated (e.g., using suitable hardware and software) given the shapes of coverage areas 112. Reference area 304 is shown in FIG. 3 as rectangular; equivalent embodiments, however, may be differently shaped in any manner. In the event reference area 304 is rectangular, it may be beneficial to define one or more corners of area 304 such that those corners correspond to the location of one or more APs 114 (e.g., a previously-placed AP). Alternatively, reference area 304 may be defined based on the position of other system components as well as barriers and the like.

Operation of the system generally proceeds as follows. First, modeling information regarding the environment and components within the environment 103 are collected to produce a spatial model. This information may include, for example, building size and layout, country code, transmit power per AP, antenna gain, placement constraints, transmit power constraints, data rate requirements, coverage requirements, barrier information, and the like. In this regard, the environment 103 within boundary 102 may be discretized or quantized into a grid or other data abstraction for computational purposes.

In one embodiment, the very first time the placement algorithm starts, AP 114A takes an initial position, which may be arbitrarily assigned to any suitable position within environment 103, or otherwise determined using any appropriate technique, including. In various embodiments, for example, the initial position of AP 114A is computed based upon a suitable formula and may be constrained by RF coverage requirements, environmental factors (e.g. building materials, presence of walls or other obstructions, etc.), and the like.

In various embodiments, the grid or other quantized data abstraction mentioned above may be used to assist in initial placement of RF transmitters. According to one exemplary technique, the first transmitter may be placed with reference to a corner or other point of reference within environment 103. FIG. 3A shows AP 114A placed within environment 103 at a location having coordinates (X′, Y′) as determined with respect to corner 352; in equivalent embodiments, other corners or points within environment 103 could be used as a starting reference point. The initial values of X′ and Y′ could be selected as any default value (including zero), as any value determined with respect to the size of environment 103 (e.g. determined from a midpoint, quarter-point or other position related to the horizontal, vertical and/or lateral length of environment 103), or according to any other technique. In some embodiments, the initial values may be computed as any function of AP transmit power, threshold RSSI, data transmit frequency, and/or any other RF factors as appropriate. One formula that could be used, for example, relates the initial distance (D) from a corner of the environment to various RF factors as follows:

$$D = {10}^{\frac{( {P}_{TX} - RSSI + 37 - 20 {log}_{10} ( f ) )}{20}}$$

wherein “PTX” is the transmitter power in dBm, RSSI is the threshold acceptable signal strength in dBm, and f is the transmit frequency in megahertz. The resulting value for “D” is expressed in feet (but is readily convertible to meters by simply multiplying by 0.3048). Of course the particular values shown in the equation will vary based upon the particular environment, system of measurement, and other factors. Many embodiments may similarly modify the relationship shown in the formula to adjust for building materials, presence or absence of barriers, transmitter or receiver characteristics, and/or other factors as appropriate. Further, it is assumed in this example that the distance “D” could provide a suitable starting coordinate in both the “X” and “Y” directions shown in FIG. 2 (that is, “X′” and “Y′” are initially assumed to be equal). This relation need not hold true in other embodiments, and different formulas for computing initial values of X′ and Y′ could be used in other embodiments. Still further, it is assumed that the initial value of both X′ and Y′ lie within acceptable positions in environment 103. Through simple checking of coordinates, these starting values may be adjusted if they are found to place the transmitter at an undesirable location (e.g. a stairwell, restroom or the like) or if the determined values (e.g. the values resulting from the equation above) result in a location outside of environment 103. Such adjustment may be resolved by simply modifying the X and/or Y coordinate until the issue is removed, by dividing the computed value by any appropriate scaling constant (e.g. by two), or by any other adjusting technique.

After initial placement, the size and shape of the coverage areas 112 within boundary 102 may then be determined for AP 114A, using any appropriate technique. In the embodiment shown in FIG. 3A, for example, a reference area 305 can be formed by the AP (x,y) coordinate, the leftmost outer wall of boundary 102, and the bottom outer wall of boundary 102. An optimization process is then performed to determine the best location for AP 114A. At each iteration of the process, AP 114A might have a new (x,y) coordinate but the reference area 305 definition with respect to the whole graph remains the same. Next, any contiguous gaps within reference area 305 are identified, and the shape, size, and any other suitable attributes for those gaps are computed. The coverage metric is then computed for reference area 305, based, for example, on the total area of the gap 205.

At any appropriate time (e.g. when AP 114A has settled into its final position), a new AP is suitably added, as shown in FIG. 3B. In this example, AP 114B is the second AP to be added. Again, AP 114A will take a general initial position as shown. However, in a different variation of the implementation, the position of the next—e.g. second—AP might have a special relationship with the last AP. That is, the next AP initial position might take the same y coordinate as the last AP, while the x coordinate is derived computationally. In either case, a new reference area 306 is formed by the second AP (x, y) coordinate and the same outer wall of the graphs as the previous case. The optimization process is again initiated for the second AP based only upon reference area 306. In an alternate example, the reference area 306 may be a rectangle with two corners bounded by the two APs 114A and 114B. This technique can be used to greatly reduce computation time.

APs 114A-B may be initially and subsequently placed according to any technique. In various embodiments, the number of APs is initially estimated (either automatically or by the user), with the positions of APs initially determined using any of the techniques described above. In various embodiments, the first transmitter is initially placed using the techniques described above, and then processing continues to process rows and/or columns across environment 103 using the conceptual grid as appropriate. That is, each row can be analyzed until a gap in coverage is identified, and then an additional transmitter is placed at the same column coordinate as the previous transmitter until the row is filled. Processing then continues with the next unfilled row until the corner opposite the starting point 352 is reached. Of course columnar processing could be readily substituted for row processing, or any other coordinate system (including angular coordinates based upon angular position and radius from a starting point) could be used in any number of equivalent embodiments. In another variation of this implementation, the system might arrange the second row (or column) of APs to be in a staggered position with respect to the previous row (or column) for the purpose of further reducing the cluster effects. That is, the first and second coordinates of each of the plurality of RF devices are determined to create a staggered pattern with respect to the position of the other RF devices.

In such embodiments, the two transmitters might not share common X or Y coordinates, but the second transmitter (e.g. AP 114B) could still be considered to be placed with respect to the position of the first transmitter (e.g. AP 114A). APs 114A-B need not be initially placed in linear fashion with each other, then, but may be determined according to any pre-determined placement technique based upon, for example, the relative positions of the transmitters.

When the APs are placed, the sizes and shapes of the coverage areas 112 within boundary 102 are determined for the set of APs 114 using any of the techniques described above. Any contiguous gaps (e.g., gaps 202 and 302) within environment 103 are then identified, and the shapes, sizes, and/or any other suitable attributes for each of those gaps can be computed. The coverage metric is then computed, based, for example, on the total area of the identified gaps (e.g. gaps 202 and 302 in FIG. 2).

Once the coverage metric is computed, the system determines a new position for one or more of the APs—e.g., the most recent AP to enter the environment, or the AP that is closest to a corner or other point of reference, or the like. Next, the AP (e.g., AP 114B) is moved within the spatial model to that new position. The new position may be determined by defining an angular direction in which the AP should move, as well as a step size (i.e., distance) that defines the scalar distance of movement. The distance may be selected in accordance any of the techniques described herein or with any conventionally-known principles to achieve the desired stability and convergence time.

The angular direction and quantity of AP movement during any iteration may be specified in any suitable manner based on gap sizes and/or the relative locations of gaps and APs. In one embodiment, the angular direction of AP movement corresponds to a line leading from the current placement of the AP to an extrema (i.e., a point on the perimeter) of one of the gaps. In a particular embodiment, the angular direction is defined by the point on the perimeter of the gap that is farthest away from the current position of the AP. Referring again to FIG. 2, the further extrema of gap 202 from APs 114A-B are points 252 and 258, respectively. By drawing conceptual lines between APs 114A-B and respective points 252 and 258, two possible movement vectors 254, 256 can be identified. Each of these vectors 254, 256 can be conceptually represented with an angle (θ) to the horizontal, vertical or other appropriate reference, as well as a scalar magnitude. FIG. 2, for example, shows two angles θ₁ and θ₂ representing potential directions of movement for APs 114A and 114B, respectively. Other embodiments may define direction of movement based upon a centroid or “center of mass” calculation related to the gap, or upon any other factor(s).

The distance that the AP is moved may be selected in accordance with any of various principles to achieve the desired stability and convergence time. In various embodiments, the distance is based upon the size of the gap or the distance from the AP to the gap. In various embodiments, an average gap metric can be computed based on an integration or discrete summation of the distances from the AP to one or more points within a gap. This summation may be based upon the entire area of the gap, or may be limited to the points located on the periphery of the gap. In still other embodiments, an average hole size (“W”) of all the gaps present within environment 103 may be computed, and the step size can be determined based upon this quantity. Such embodiments may thereby base the distance moved on the relative size of the hole of interest with respect to the total area of holes to be eliminated, thereby potentially reducing deleterious effects upon other holes within environment 103. The distance may also be adjusted based upon building materials, objects in the vector path and/or other factors as appropriate.

After the direction and distance of vector 254 or 256 is conceptualized, the corresponding AP 114A or 114B can be moved accordingly. Although FIG. 2 shows a potential vector for each of APs 114A-B, in practice only one AP needs to be moved during any particular iteration of the placement process. After the subject AP has been relocated, the system again determines the size and shape of the coverage areas and re-computes the coverage metric. If the coverage metric is equal to or less than a predefined threshold, the system once again computes a new position for one or more of the APs, and the process continues as before until the predefined threshold is reached or it is determined that the process should otherwise stop (e.g., due to the non-existence of a solution, non-convergence, or a time out event). The predefined threshold may be selected to achieve any particular design objective—e.g., the coverage metric value corresponding to the minimum signal level in which a certain data rate can operate.

FIG. 4 shows the example of FIG. 3B after relocation of AP 114B. As depicted, the gaps 202 and 302 of FIG. 3 have been eliminated or substantially eliminated such that the coverage metric within the previously-defined reference area are within the predefined threshold, and a new reference area 304 has been defined for the purposes of further adaptively improving coverage. The shape and size of coverage areas 112A and 112B have changed accordingly, resulting in two gaps 402 and 404 within reference area 304. The system may then proceed to improve coverage either by moving AP 114A or 114B, or adding a new AP within boundary 102.

After the subject AP has been relocated, the system again determines the size and shape of the coverage areas, redefines the reference area 304 (e.g., based on the new location of the APs within the system), and re-computes the coverage metric. If the coverage metric is equal to or less than a predefined threshold, the system once again computes a new position for one or more of the APs, and the process continues as before until the predefined threshold is reached or it is determined that the process should otherwise stop (e.g., due to the non-existence of a solution, non-convergence, or a time out event).

Many variations, additions or deletions could be made to the above techniques in a wide array of equivalent embodiments. The reference areas 304, 305, 306 can enclose more than one RF transmitter, for example, as a variation of the basic placement method. In such cases, the coverage metric can be computed and analyzed simultaneously or sequentially for each transmitter residing inside that reference boundary.

The methods described above may be performed in hardware, software, firmware or any combination thereof. For example, in one embodiment one or more software modules are configured to be stored on a digital storage medium (e.g. a disk, memory and/or the like) and executed on a general purpose computer having a processor, memory, I/O, display, and/or other suitable components.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes any and all known equivalents and foreseeable equivalents at the time of filing this patent application.

What is claimed is:

1. A method of positioning a plurality of RF devices each providing a coverage area within an environment, the method comprising the steps of:
defining a spatial model associated with the environment and comprising a reference point;
initially placing a first one of the plurality of RF devices at a first initial location within the spatial model, wherein the first initial location is determined with respect to the reference point;
determining the coverage area for the first RF device;
initially placing a second one of the plurality of RF devices at a second initial location within the spatial model, wherein the second initial location is determined with respect to the coverage area of the first RF device; and
adjusting at least one of the first and second initial locations to improve the combined coverage area of the first and second RF devices.

2. The method of claim 1 wherein the first initial location is determined to be a computed distance from the reference point.

3. The method of claim 1 wherein the spatial model comprises a first coordinate and a second coordinate, and wherein the first and second initial locations are defined by values of the first and second coordinates.

4. The method of claim 3 wherein the second initial position comprises either a first coordinate value or a second coordinate value that is substantially equal to that of the first initial position.

5. The method of claim 3 wherein the first and second coordinates of each of the plurality of RF devices are determined to create a staggered pattern with respect to the position of the other RF devices.

6. The method of claim 2 wherein the computed distance (D) is computed based at least in part upon the following relationship:
$$D = {10}^{\frac{( {P}_{TX} - RSSI + 37 - 20 {log}_{10} ( f ) )}{20}}$$
wherein P_{TX} is the transmitter power in dBm, RSSI is the threshold acceptable signal strength in dBm, and f is the transmit frequency in megahertz.

7. The method of claim 3 wherein the value of at least one of the two coordinates for the first initial position is computed based upon the following relationship:
$$D = {10}^{\frac{( {P}_{TX} - RSSI + 37 - 20 {log}_{10} ( f ) )}{20}}$$
wherein D is the value of the at least one of the two coordinates, P_{TX} is the transmitter power in dBm, RSSI is the threshold acceptable signal strength in dBm, and f is the transmit frequency in megahertz.

8. A digital storage medium having computer-executable instructions stored thereon, the instructions configured to execute the method of claim 1.

9. A system for positioning an RF device within an environment, comprising:
a processor configured to accept a spatial model associated with the environment and comprising a reference point, to initially place a first one of the plurality of RF devices at a first initial location within the spatial model, wherein the first initial location is determined with respect to the reference point, to determine the coverage area for the first RF device, to initially place a second one of the plurality of RF devices at a second initial location within the spatial model, wherein the second initial location is determined with respect to the coverage area of the first RF device, and to adjust at least one of the first and second initial locations to improve the combined coverage area of the first and second RF devices; and
a display for displaying the spatial model and the second placement location.

10. The system of claim 9, wherein the RF device is a wireless access point.

11. The system of claim 10, wherein the wireless access point conforms to an 802.11 specification.

12. The system of claim 10, wherein the RF device is selected from the group consisting of a WiMax device, a Bluetooth device, a Zigbee device, a UWB device, and a RFID device.

13. A method of positioning a plurality of RF devices within an environment, the method comprising the steps of:
defining a spatial model associated with the environment, the spatial model having a reference point and a grid structure that is addressable by a first (X) coordinate and a second (Y) coordinate;
initially placing a first one of the plurality of RF devices at a first initial location (X′,Y′) within the spatial model, wherein each of the first and second coordinates X′ and Y′ are mathematically determined with respect to the reference point;
determining a coverage area associated with the first RF device;
initially placing a second one of the plurality of RF devices at a second initial location within the spatial model, wherein at least one of the first and second coordinates of the second initial location are initially set to correspond to the first and second coordinates, respectively, of the location of the first RF device; and
adjusting at least one of the first and second initial locations to improve the combined coverage area of the first and second RF devices.

14. The method of claim 13 wherein the location of the first RF device is adjusted based upon the coverage area prior to initially placing the second RF device.

15. The method of claim 13 wherein the locations of the first RF device and second RF device are adjusted substantially simultaneously.

16. The method of claim 13 wherein the adjusting step takes place after the initial placing of the first and the second RF devices.

17. The method of claim 13 wherein the computed distance (D) is computed based at least in part upon the following relationship:
$$D = {10}^{\frac{( {P}_{TX} - RSSI + 37 - 20 {log}_{10} ( f ) )}{20}}$$
wherein D is the value of the at least one of the two coordinates, P_{TX} is the transmitter power in dBm, RSSI is the threshold acceptable signal strength in dBm, and f is the transmit frequency in megahertz.

18. The method of claim 17, further including the steps of:
identifying a set of gaps in the coverage areas associated with the plurality of RF devices in the environment;
determining a coverage metric based on a set of gaps in the coverage areas of the first and second RF devices, and repeating the step of identifying the set of gaps within when the coverage metric is greater than a pre-determined threshold; and
repeating the gap identification, coverage metric determination and adjusting steps until the coverage metric reaches at least a threshold value.

19. The method of claim 18 wherein first and second RF devices are both adjusted in response to the determining step.

20. A digital storage medium having computer executable instructions stored thereon, wherein the computer-executable instructions are configured to execute the method of claim 13.
